(19) United States
(12) Patent Application Publication
(10) Pub. No.: US 2005/0011553 A1
(43) Pub. Date: Jan. 20, 2005

(54) Steam Trap and Valve Mount Assembly

(75) Inventor: Sanjeev S. Moghe, Northfield Center, OH (US)

Correspondence Address: CALFEE HALTER & GRISWOLD, LLP, 800 SUPERIOR AVENUE, SUITE 1400, CLEVELAND, OH, 44114, US

(73) Assignee: SWAGELOK COMPANY, Solon, OH (US)

(21) Appl. No.: 10/709,966

(22) Filed: Jun. 9, 2004

Related U.S. Application Data
(60) Provisional application No. 60/320,258, filed on Jun. 9, 2003.

(51) Int. Cl. F16T 1/00

(52) U.S. Cl. 137/183

(57) ABSTRACT

A steam trap mounting arrangement includes a mount body that includes one or more integral flanges. The flanges function as end fittings for associated ball valves. The mount may be a single casting, such as a metal casting. The mount may further be a universal mounting that permits a plurality of different steam trap configurations to be installed thereon.

### CROSS REFERENCE TO RELATED APPLICATIONS

This application claims the benefit of pending U.S. Provisional patent application Ser. No. 60/320,258 filed on Jun. 9, 2003 for INTEGRATED STEAM TRAP TEST ASSEMBLY, the entire disclosure of which is fully incorporated herein by reference.

### BACKGROUND OF INVENTION

A steam trap is an automatic valve designed to remove condensate, air, and CO2 from a steam system. The trap opens automatically to discharge condensate and closes to prevent release of steam from the system.

A steam trap may be mounted on a universal mount, adapted to support steam traps of differing constructions made by differing manufacturers. In some steam systems a steam trap is located between two shutoff valves, for the purpose of testing the steam trap. The steam trap is tested by closing the downstream valve. If the trap is still good, condensate comes out of the vent of the downstream valve. If the trap has failed, steam comes out of the vent of the downstream valve. If the valve is determined to have failed, the upstream valve is closed to isolate the trap so that it can be replaced.

Valves that are sometimes used in this testing configuration are 60 series ball valves sold by Swagelok Company of Solon, Ohio, as shown generally in U.S. Pat. No. 4,410,165, the entire disclosure of which is incorporated herein by reference. These ball valves have flanges on either end that together with a series of bolts, hold the ball valves together. The flanges provide a location for connection with the steam trap mount.

The steam trap mount is typically connected between the ball valves with a series of fittings and with tubing or NPT piping, to form a steam trap test valve assembly. One such prior art test valve assembly 10 is shown in FIG. 1.

The assembly 10 includes an upstream valve 12. The upstream valve 12 has a valve body 14, an inboard flange 16, and an outboard flange 18. Each one of the flanges 16 and 18 has a plurality of fastener openings 20 arranged in a predetermined pattern. A plurality of fasteners 22 extend through the fastener openings 20 in the flanges 16 and 18 to secure together the parts of the upstream valve 12.

The assembly also includes a downstream valve 24. The downstream valve 24 is similar in configuration to the upstream valve 12. The downstream valve 24 has a valve body 26, an inboard flange 28, and an outboard flange 30. Each one of the flanges 28 and 30 has a plurality of fastener openings 32 arranged in a predetermined pattern. A plurality of fasteners 34 extend through the fastener openings 32 in the flanges 28 and 30 to secure together the parts of the downstream valve 24.

The assembly 10 further includes a steam trap mount 40. The steam trap mount 40 may be a “universal” mount that is adapted to support steam traps of different configurations from different manufacturers. The mount 40 has a central body portion 42 with a mounting disk 44 that is adapted to support a steam trap (not shown).

The prior art test assembly 10 includes a plurality of fittings 46, and piping or tubing 48, connected between the upstream valve 12 and the steam trap mount 40. The prior art test assembly 10 also includes a plurality of fittings 50, and piping or tubing 52, connected between the downstream valve 24 and the steam trap mount 40. This can require a substantial amount of machining and a significant amount of labor to assemble.

### SUMMARY OF INVENTION

The invention contemplates a mounting arrangement for a steam trap that facilitates testing and use of the steam trap. In accordance with one aspect of the invention, a mount is provided that is adapted to have a steam trap installed thereon, and includes one or more flanges that form part of a valve. In one embodiment, the mount includes two flanges which respectively allow an upstream and downstream valve to be mounted thereon.

In accordance with another aspect of the invention, a steam trap mount is contemplated that includes one or more integral valve mounting flanges. The flanges function as end fittings for associated valves so as to eliminate intermediate fluid couplings between the valves and the mount. In one embodiment, the valves are ball valves.

In accordance with another aspect of the invention, a steam trap mount is contemplated that provides a universal mounting that allows a plurality of different steam trap mounting configurations to be installed thereon.

In accordance with another aspect of the invention, a steam trap mount is provided that is adapted to have a steam trap installed thereon and further includes one or more integral flanges, in which the mount comprises a single casting. In a further embodiment, the single casting comprises metal.

### BRIEF DESCRIPTION OF DRAWINGS

These and other aspects of the invention will be described herein and readily understood by those skilled in the art from a reading of the detailed description and the accompanying drawings wherein:

FIG. 1 illustrates a prior art steam trap mounting arrangement;

FIG. 2 illustrates a steam trap mounting arrangement in accordance with the present invention;

FIG. 3 is an isometric illustration of one embodiment of a steam trap mount in accordance with the invention; and

FIG. 4 is a top view of the embodiment of FIG. 3.

### DETAILED DESCRIPTION

The present invention relates to a steam trap mounting arrangement and particularly to a mounting arrangement that facilitates valve installation with such an arrangement. The complete assembly is especially useful for testing a steam trap in a steam system, although testing is not a requirement for the present invention. The assembly may be installed in a steam system and normally operates as a steam trap alone. When it is desired to test the steam trap, the assembly is operated as described above to determine whether the steam trap is still working or has failed.

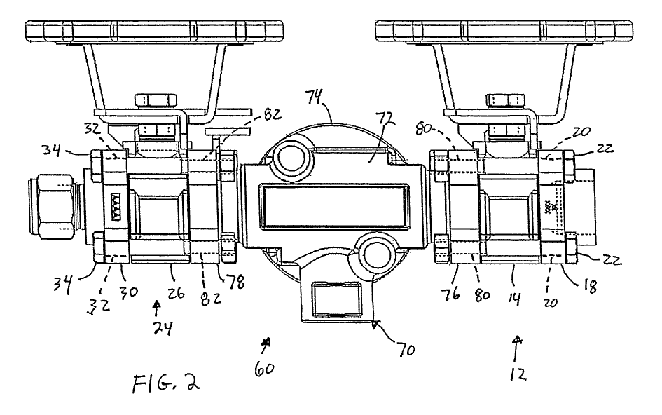

A steam trap mounting arrangement in accordance with the invention may take many different forms, shapes or configurations. An exemplary embodiment of the invention is the steam trap assembly 60 shown in FIG. 2.

The assembly 60 includes a valve body 14 and an outboard flange 18 of an upstream valve 12. The assembly also includes a valve body 26 and an outboard flange 30 of a downstream valve 24.

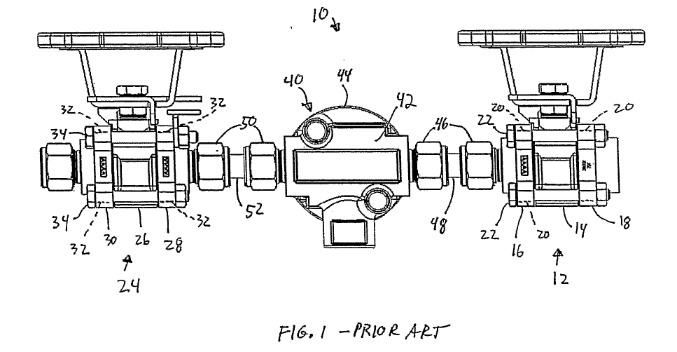

The assembly 60 further includes a steam trap mount 70. The steam trap mount 70 may be but need not be a “universal” mount that is adapted to support a plurality of steam traps of different configurations, such as from different manufacturers. The mount 70 has a central body portion 72 with a mounting disk 74 that is adapted to support a steam trap (not shown). The mounting disk may have, for example, the same configuration as the mounting disk 42 of the prior art steam trap mount 40 that is shown in FIG. 1.

The mount 70 includes an upstream mounting flange 76 and a downstream mounting flange 78 that are located on opposite ends of the central body portion 72. The upstream mounting flange 76 has a plurality of fastener openings 80 arranged in a predetermined pattern. The pattern of the fastener openings 80 in the upstream mounting flange 76 of the mount 70 may be the same as the pattern of the fastener openings 20 in the inboard flange 16 (FIG. 1) of the upstream valve 12.

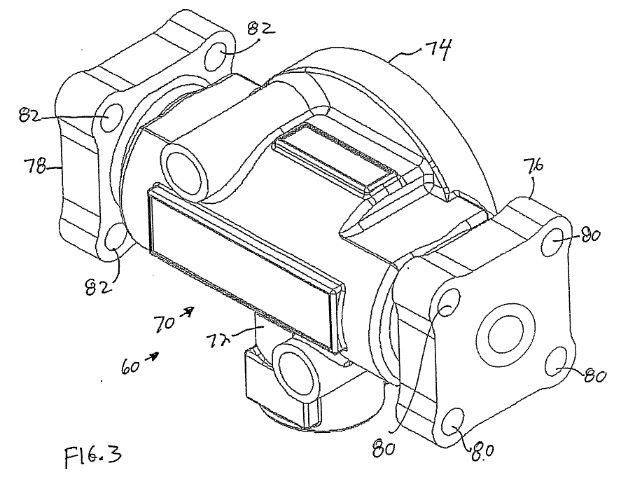

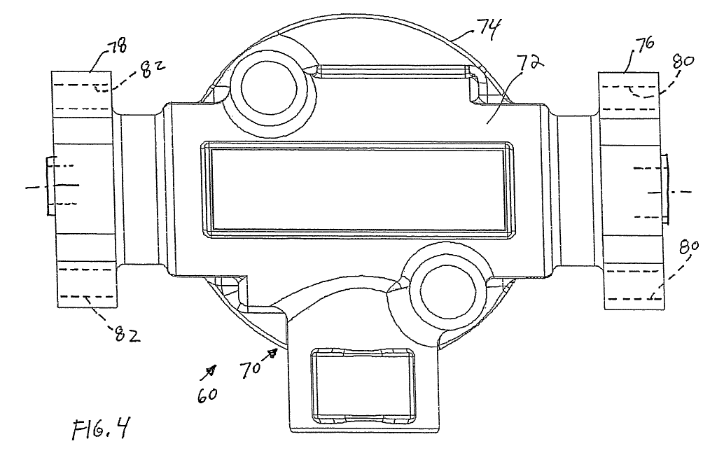

The downstream mounting flange 78 (FIGS. 2-4) of the steam trap mount 70 has a plurality of fastener openings 82 arranged in a predetermined pattern. The pattern of the fastener openings 82 in the downstream mounting flange 78 of the mount 70 may be the same as the pattern of the fastener openings 32 in the inboard flange 28 (FIG. 1) of the downstream valve 24. The downstream mounting flange 78 (FIGS. 2-4) may be identical in configuration to the upstream mounting flange 76.

Because the pattern of the fastener openings 80 in the upstream mounting flange 76 of the steam trap mount 70 is the same as the pattern of the fastener openings 20 in the inboard flange 16 of the upstream valve 12, the mount 70 can be connected directly to the valve body 14 of the upstream valve, as shown in FIG. 2, replacing the inboard flange of the upstream valve. A plurality of fasteners 22 extend through the fastener openings 20 in the outboard flange 18 of the upstream valve 12, and through the fastener openings 80 in the upstream mounting flange 76 of the mount 70, to secure together the parts of the upstream valve 12. The fasteners 22 also secure the upstream valve 12 to the steam trap mount 70.

Similarly, because the pattern of the fastener openings 82 in the downstream mounting flange 78 of the steam trap mount 70 is the same as the pattern of the fastener openings 32 in the inboard flange 28 (FIG. 1) of the downstream valve 24, the mount 70 can be connected directly to the valve body 26 of the downstream valve, as shown in FIG. 2, replacing the inboard flange of the downstream valve. A plurality of fasteners 34 extend through the fastener openings 32 in the outboard flange 30 of the downstream valve 12, and through the fastener openings 82 in the downstream mounting flange 78 of the mount 70, to secure together the parts of the downstream valve 12. The fasteners 34 also secure the downstream valve 24 to the steam trap mount 70.

As such, each of the flanges 76 and 78 function the same as the end fittings of the valves 12 and 24. As end fittings (see for example the above patent incorporated herein by reference) the flanges are used to compress a valve seat against a portion of the associated valve body.

Because the mounting flanges 76 and 78 are preferably integrated into the steam trap mount 70, no extra pipes, tubes, or fittings are needed to connect the valves 12 and 24 with the steam trap mount 70. This eliminates the piping and fittings 46, 48, 50 and 52 that are needed in the prior art test assembly 10. This reduces significantly the amount of labor and parts that are needed to produce the test assembly 60, thus lowering cost, as compared to the prior art test assembly 10 that is shown in FIG. 1.

By “integrated” is simply meant that the flanges 76, 78 are joined to or part of the central body portion 72. The flanges may be attached to the central body by any suitable technique. In a preferred but not required embodiment, the mount 70 is realized in the form of a single casting, mold or similar structure. For example, the single casting may comprise a metal casting such as cast stainless steel. When formed as a single casting, the flanges 76, 78 are structurally integral and continuous with the central body.

1. A steam trap mount, comprising:
a main body adapted to have a steam trap mounted thereon;
at least one valve mounting flange integral with said main body, said valve mounting flange adapted to have a valve mounted thereon and wherein said valve mounting flange forms part of a valve when assembled thereto.

2. The mount of claim 1 wherein said valve mounting flange comprises an end fitting for a valve, said end fitting cooperating with a valve body and a second end fitting to enclose the valve when assembled.

3. The mount of claim 2 wherein the valve is a ball valve and said end fitting secures a ball element within said valve body.

4. The mount of claim 1 wherein said main body is adapted to be a universal mount for a plurality of different steam trap designs.

5. The mount of claim 1 wherein said valve mounting flange can be bolted to a valve body to enclose a ball element therein.

6. The mount of claim 1 wherein said main body and flange comprise a single casting.

7. The mount of claim 6 wherein said casting comprises cast metal.

8. A steam trap and valve mount assembly, comprising:
a steam trap;
a mounting body with said steam trap mounted thereon;
at least one valve mounting flange integral with said main body;
at least one valve mounted on said valve mounting flange;
said valve mounting flange forming part of said valve when assembled therewith.

9. The assembly of claim 8 wherein said valve comprises a ball valve; said flange functioning as an end fitting for said ball valve.

10. The assembly of claim 9 wherein said end fitting cooperates with a valve body and another end fitting to enclose said valve.

11. The assembly of claim 10 wherein said ball valve comprises a ball seat that is compressed between said flange and a portion of said valve body.

12. The assembly of claim 8 comprising a second valve installed on said mounting body; said mounting body comprising a second mounting flange with said second valve mounted thereon.

13. The assembly of claim 12 wherein said valves are mounted on opposite sides of said mounting body.

14. The assembly of claim 8 wherein each said valve comprises an axis of flow therethrough, said valves being installed on said mounting body so that said valve flow axes are coaxial.

15. The assembly of claim 12 wherein said valves operate to function as a test assembly for said steam trap.

16. The assembly of claim 8 wherein said mounting body and flange comprise a single casting.

17. The assembly of claim 16 wherein said single casting comprises cast metal.

18. The assembly of claim 8 wherein said main body is adapted to be a universal mount for a plurality of different steam trap designs.

19. A steam trap mount and valve assembly, comprising:
a mounting body adapted to have a steam trap mounted thereon;
at least one valve mounting flange integral with said main body;
at least one valve mounted on said valve mounting flange;
said valve mounting flange forming part of said valve when assembled therewith.

20. The assembly of claim 19 wherein comprising two valve mounting flanges and a respective valve mounted on each flange.

21. The assembly of claim 19 wherein said mounting body and flange comprise a single casting.

22. The assembly of claim 21 wherein said single casting comprises a metal casting.
